(19) United States
(12) Patent Application Publication
(10) Pub. No.: US 2022/0102034 A1
(43) Pub. Date: Mar. 31, 2022

(54) Method for preparation of a sintered type NdFeB permanent magnet with an adjusted grain boundary

(71) Applicant: Yantai Dongxing Magnetic Materials Inc., Yantai (CN)

(72) Inventors: Chuanshen WANG, Yantai (CN); Kunkun YANG, Yantai (CN); Zhongjie PENG, Yantai (CN); Kaihong DING, Yantai (CN)

(21) Appl. No.: 17/489,691

(22) Filed: Sep. 29, 2021

(30) Foreign Application Priority Data
Sep. 29, 2020 (CN) 202011051159.8

(51) Int. Cl. H01F 1/057; H01F 41/02

(52) U.S. Cl. CPC H01F 1/0577; H01F 41/0293

(57) ABSTRACT

The disclosure relates to a method for preparing sintered type NdFeB permanent magnet. The NdFeB magnet is covered with a diffusion source to form a NdFeB magnet intermediate. The diffusion source refers to an alloy, the alloying elements include one or more of Nd, Pr, Ce, La, Ho, Tb, Dy, Ga, Al, Cu, and Mg. The NdFeB magnet intermediate is then put into a furnace and a diffusion treatment and subsequently an aging treatment is performed. The aging treatment is divided into a heating step and a cooling step. The cooling step is carried out by means of argon gas positive pressure circulation cooling such that NdFeB magnets with a thickness of grain boundaries in the range of 10 nm to 1 μm are formed.

### BACKGROUND OF THE DISCLOSURE

### 1. Field of the Disclosure

The disclosure relates to the technical field of sintered type NdFeB permanent magnets, in particular to a method for preparing sintered type NdFeB permanent magnet with an adjusted grain boundary. The method may increase the coercivity of the sintered type NdFeB permanent magnet.

### 2. Description of the Prior Art

NdFeB sintered permanent magnet called “magnet kings” have been widely used since its inception and has been deeply rooted in modern society. It is widely used in high-tech fields such as electronic information, medical equipment, new energy vehicles, household appliances, robots, etc. With the rapid development of informatization and industrialization, high-performance magnets have become a current research hotspot.

In 2005, Nakamura reported a simple and rapid way to increase coercivity by diffusing heavy rare-earth oxides and fluoride powders on NdFeB permanent magnets, which is called “grain boundary diffusion process”. With the development of diffusion technology, two diffusion mechanisms are formed, that is, hardening Nd2Fe14B main phase with heavy rare earth elements to the form a large number of core-shell structures or broadening and diluting grain boundary of ferromagnetic phase.

At present, the diffusion of heavy rare earths is the most significant effect of improving coercivity, but the heavy rare earths is extremely expensive, and the abundance of heavy rare earths is poor. Therefore, more and more researchers are seeking to reduce the amount of heavy rare earths or not use them in NdFeB sintered permanent magnet. In short, the development of magnet containing very low or no heavy rare earths has become a research hotspot.

It is very important to control the grain boundary, that is, the non-magnetic phase in the grain boundary, and effectively cut off the magnetic exchange coupling of the magnet. Such as, patent literatures CN 104078176 A and JP2014209546 A show, in order to improve the coercivity, the segregation of ferromagnetic phases are suppressed in the grain boundary phase through the cooling rate forming the R6T13M phase of the La6Co11Ga13 type crystal structure. Patent literature CN 108878090 reveals the high performance non-heavy rare earth NdFeB sintered permanent magnet has clear grain boundary through controlling the content of various elements and low-temperature aging. Patent literature CN 105206417 A realizes the gas phase isolation of magnetic powder particles and crystal grains through the heated gasification of sulfur to make the low melting point alloy rare earth-copper aluminum. The alloy is completely separated from the main phase to obtain high coercivity. Patent literature CN 102290181 A realizes a low-cost high-performance neodymium iron boron magnet without heavy rare earth or very low heavy rare earth. However, the above-mentioned magnets do not give effective method of adjustable grain boundary.

### SUMMARY OF THE DISCLOSURE

The present disclosure provides a preparation method for a sintered type NdFeB permanent magnet as defined in claim 1. The method includes the steps of:

(1) Covering a NdFeB magnet with a diffusion source to form a NdFeB magnet intermediate, the chemical composition of the NdFeB magnet intermediate is expressed in weight percentage as [R1ₓR2_{y}R3_{1-x-y}]ₐM_{b}B_{c}Fe_{100-a-b-c},

with 0.8≤x≤1, 0≤y≤0.08, 32≤a≤38, 0.5≤b≤7, and 0.9≤c≤1.2,

R1 being one or more of Nd, Pr, and Ce,

R2 being one or more of La and Sm,

R3 being one or more of Tb, Dy, and Ho,

M being one or more of Al, Cu, Ga, Ti, Co, Mg, Zn, Nb, Mo, and Sn, and

wherein the diffusion source refers to an alloy including two or more of the alloying elements Nd, Pr, Ce, La, Ho, Tb, Dy, Ga, Al, Cu, and Mg;

(2) Putting the NdFeB magnet intermediate into a furnace and performing a diffusion treatment and subsequently an aging treatment, wherein the aging treatment is divided into a heating step and a cooling step and

wherein the cooling step is carried out by means of argon gas positive pressure circulation cooling such that NdFeB magnets with a thickness of grain boundaries in the range of 10 nm to 1 μm are formed, a structure of the grain boundaries includes a main phase, grain boundary (a), grain boundary (b), and grain boundary (c),

wherein grain boundary (a) meets the following conditions: R≥55 wt % or 35 wt %≤R≤40 wt %, 10 wt %≤M≤28 wt %, where 3:1≤Nd/(Pr or Ce or La)≤2:1, and (Cu+Al+Ga)/M≥0.8;

grain boundary (b) meets the following conditions: 40 wt %≤R≤55 wt %, 10 wt %≤M≤20 wt %, 9:10≤Nd/(Pr or Ce or La)≤2, and (Cu+Co+Al)/M≥0.9; and

grain boundary (c) meets the following conditions: 25 wt %≤R≤50 wt % or R≥60%, 0≤M≤10 wt %,

where R in the grain boundaries (a) to (c) refers to the total amount of rare earths, and M refers to the total amount of Al, Cu, Ga, Ti, Co, Mg, Zn, Nb, Mo, and Sn.

Further embodiments of the present disclosure could be learned from the dependent claims and the following description.

### BRIEF DESCRIPTION OF THE FIGURES

FIG. 1 schematically shows the NdFeB magnet intermediate.

FIG. 2 shows the grain boundary structure of the NdFeB magnet before Grain Boundary Diffusion (GBD).

FIG. 3 shows the grain boundary structure of the NdFeB magnet of Example 2 (SEM images of the microstructure of Nd—Fe—B permanent magnets after diffusion using backscattered electron (BSE) contrast).

FIG. 4 shows the grain boundary structure of the NdFeB magnet of Example 3.

FIG. 5 shows the grain boundary structure of the NdFeB magnet of Example 7.

FIG. 6 shows the grain boundary structure of the NdFeB magnet of Example 12.

FIG. 7 shows the grain boundary structure of the NdFeB magnet of Example 13.

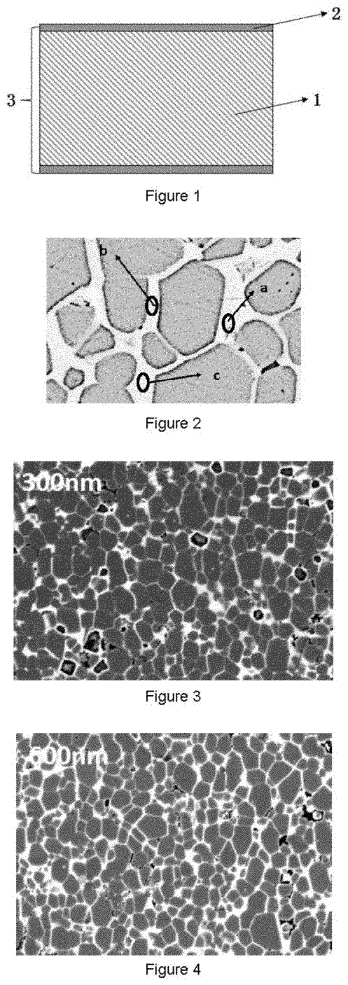

### DETAILED DESCRIPTION OF THE DISCLOSURE

The principles and features of the disclosure are described below, and the examples are only intended to be illustrated and not to limit the scope of the disclosure as defined by the present claims.

FIG. 1 schematically shows the NdFeB magnet intermediate 3, which is composed of a NdFeB magnet 1 and a covering of a diffusion source 2.

The present disclosure proposes a method for preparing sintered type NdFeB permanent magnet with adjustable grain boundaries. A NdFeB sintered permanent magnet is prepared through the synergistic effect between the elements of the magnet composition and the diffusion source, and in particular by controlling the composition ratio of the magnet composition and the diffusion source. Furthermore, clear grain boundary can improve the coercivity of NdFeB sintered permanent magnet by controlling the content of C, O, and N in the atmosphere and by argon air cooling.

In order to achieve the aforementioned purpose of the disclosure, the method for preparing sintered type NdFeB permanent magnet includes the following steps:

The NdFeB magnet is covered with a diffusion source to form a NdFeB magnet intermediate. The chemical composition of NdFeB magnet intermediate is expressed in weight percentage as [R1ₓR2_{y}R3_{1-x-y}]ₐM_{b}B_{c}Fe_{100-a-b-c}, 0.8≤x≤1, 0≤y≤0.08, 32≤a≤38, 0.5≤b≤7, and 0.9≤c≤1.2. R1 refers to one or more of Nd, Pr, and Ce, R2 refers to one or two of La and Sm, R3 refers to one or more of Tb, Dy, and Ho, and M refers one or more of Al, Cu, Ga, Ti, Co, Mg, Zn, Nb, Mo, and Sn. The diffusion source refers to an alloy, the alloying elements include one or more of Nd, Pr, Ce, La, Ho, Tb, Dy, Ga, Al, Cu, and Mg.

The NdFeB magnet intermediate is put into a furnace and a diffusion treatment and subsequently an aging treatment is performed. The aging treatment is divided into a heating step and a cooling step. The cooling step is carried out by means of argon gas positive pressure circulation cooling such that NdFeB magnets with a thickness of grain boundaries in the range of 10 nm to 1 μm, preferably 30 nm to 800 nm, are formed. A structure of the grain boundaries includes a main phase, grain boundary (a), grain boundary (b), and grain boundary (c).

Grain boundary (a) meets the following conditions: R≥55 wt % or 35 wt %≤R≤40 wt %, 10 wt %≤M≤28 wt %, where 3:1≤Nd/(Pr or Ce or La)≤2:1, and (Cu+Al+Ga)/M≥0.8;

grain boundary (b) meets the following conditions: 40 wt %≤R≤55 wt %, 10 wt %≤M≤20 wt %, 9:10≤Nd/(Pr or Ce or La)≤2, and (Cu+Co+Al)/M≥0.9; and

grain boundary (c) meets the following conditions: 25 wt %≤R≤50 wt % or R≥60%, 0≤M≤10 wt %,

where R in the grain boundaries (a) to (c) refers to the total amount of rare earths, and M refers to the total amount of Al, Cu, Ga, Ti, Co, Mg, Zn, Nb, Mo, and Sn.

The grain boundary thicknesses and their compositions are measured by Zeiss EVOMA10 (SEM) Scanning Electron Microscope Measurement and EDS (Energy Dispersive Spectrometer) respectively.

Grain boundary (a) is the trigonometric position 1, which is in junction of the three main phases. Grain boundary (b) is the two grain boundary phase position. Grain boundary (c) is the trigonometric position 2, which is in junction of the three main phases.

According to the present method, the aging treatment is divided into a heating process and a cooling process. Argon gas is used for the cooling process. The pressure and temperature of argon gas may determine the cooling rate of magnets. A temperature of argon gas may be 10° C. to 20° C., preferably 15° C. Furthermore, a pressure of the argon gas used for argon gas positive pressure circulation cooling is in the range of 1 bar to 5 bar

The NdFeB magnet is cooled down by the argon gas, which may pass through a (copper) tube-fin type annular exchanger. Thereby, a uniform cooling rate is achieved. The pressure of the circulated argon gas is an important parameter of the process as demonstrated in below Examples 1 to 13. The composition of the NdFeB magnet intermediate and the argon pressure together determine the grain boundary thickness. In other words,

The way of cooling using the tube-fin type annular exchanger may include vertical cooling or parallel cooling or vertical and parallel alternating cooling.

Furthermore, the temperature for diffusion treatment of the NdFeB magnet is preferably in the range of 850° C. to 920° C. for 6 h to 20 h. The temperature for aging treatment is preferably in the range of 420° C. to 680° C. for 3 h to 10 h.

Furthermore, the method of covering the diffusion source on the NdFeB magnet may be any one of magnetron sputtering coating, vapor deposition coating, slurry coating, and sticking powder coating.

The NdFeB magnet intermediate may refer to non-heavy rare earth type intermediate or heavy rare earth type intermediate.

The chemical composition of the non-heavy rare earth NdFeB magnet intermediate may be [R1ₓR2₁₋ₓ]ₐM_{b}B_{c}Fe_{100-a-b-c}

with 0.94≤x≤1, 32≤a≤37, 1.55≤b≤7, and 0.95≤c≤1.2,

R1 being one or more of Nd, Pr, and Ce,

R2 being one or two of La and Sm, and

M being one or more of Al, Cu, Ga, Ti, Co, Mg, Zn, and Sn.

According to further embodiments, the chemical composition of the non-heavy rare earth NdFeB magnet intermediate fulfils one or more of the following conditions:
When R1 includes Nd and Pr, their weight ratio is 0.03≤Pr/Nd≤0.6.
When R2 includes La and Sm, their weight ratio is 0.5≤La/Sm≤2.
When M includes Cu and Al, their weight ratio is 0≤Cu/Al≤6.5.
When M includes Cu and Ga, their weight ratio is 0≤Cu/Ga≤5.
When M includes Mg and Al, their weight ratio is 0≤Mg/Al≤6.

The chemical composition of the heavy rare earth type NdFeB magnet intermediate may be [R1ₓR3_{y}R2_{1-x-y}]ₐM_{b}B_{c}Fe_{100-a-b-c}

with 32.5≤a≤38 (preferably 32≤a≤36), 0.8≤x≤0.98, 0.003≤y≤0.3, 1.5≤b≤7, and 0.9≤c≤1.2,

R1 being one or more of Nd, Pr and Ce,

R2 being one or two of La and Sm,

R3 being one or more of Tb, Dy and Ho, and

M being one or more of Al, Cu, Ga, Ti, Co, Mg, Zn, and Sn.

According to further embodiments, the chemical composition of the heavy rare earth type NdFeB magnet intermediate fulfils one or more of the following conditions:
When R1 includes Nd and Pr, and 0.03≤Pr/Nd≤0.4.
When R2 includes La and Sm, their weight ratio is 0.5≤La/Sm≤2.
When M includes Cu and Al, their weight ratio is 0≤Cu/Al≤6.5.
When M includes Cu and Ga, their weight ratio is 0≤Cu/Ga≤5.
When M includes Mg and Al, their weight ratio is 0≤Mg/Al≤6.

The content of B may preferably be 0.92≤c≤1.0.

Furthermore, the non-heavy rare earth NdFeB magnet coercivity can attain 1990 kA/m or more after high temperature and aging treatment.

Furthermore, the heavy rare earth type [R1ₓR3_{y}R2_{1-xy}]ₐM_{b}B_{c}Fe_{100-a-b-c}, wherein 32.5≤a≤38, 0.8≤x≤0.98, 0.003≤y≤0.3, 1.5≤b≤7, 0.95≤c≤1.2, wherein R1 refers to one or more of Nd, Pr and Ce, R2 refers to one or two of La and Sm, R3 refers to one or more of Tb, Dy and Ho, and M refers to multiple combinations of Al, Cu, Ga, Ti, Co, Mg, Zn, and Sn, the optimal range is 33≤a≤37, such as 34 wt %, 35 wt %, and wt % is the weight percentage of the element in the NdFeB magnet intermediate;

and/or the heavy rare earth is added in the smelting process, and the optimal range is 0.05-0.12;

and/or when R1 includes Nd and Pr, and 0.03≤Pr/Nd≤0.4;

and/or, the values of R2 and M in the heavy rare earth type NdFeB magnet intermediate are equivalent to the values of R2 and M in the non-heavy rare earth NdFeB magnet.

Furthermore, heavy rare earth NdFeB magnet coercivity can attain 2308.4 kA/m or more after high temperature and aging treatment.

Compared with the prior art, the present disclosure has the following advantages:

NdFeB magnet intermediate of specific composition is formed by a matching combination between the magnet composition and the diffusion source composition. The grain boundary thickness can be controlled effectively by the diffusion temperature, the aging temperature, and the argon gas positive pressure cooling. Mass production of products can be achieved by simple experimental conditions.

The non-heavy rare earth NdFeB magnet coercivity can attain 1990 kA/m or more. For example, a heavy rare earth NdFeB magnet including 1.13 wt % of Tb showed a coercivity of 2308.4 kA/m.

The production cost is greatly reduced, and it is suitable for industrial production.

Higher coercivity of NdFeB magnet with low or no heavy rare earth content can be achieved.

The method has not harsh requirements for C, O, and N and other atmosphere elements, which is easy for mass production.

The disclosure proposes that the thickness of grain boundary can be accurately controlled to achieve specific performance of the magnet by the matching combination between the magnet composition and the diffusion source composition and experimental conditions.

The NdFeB magnet intermediates are formed through coating NdFeB magnets with a diffusion source. The examples are as followings.

### Example 1

1) Prepare a NdFeB magnet intermediate, which meets the requirement that the total amount of Pr, Nd, and Ce is 34.67 wt %, the ratio of Pr/Nd is 0.16, the content of Tb is 1.13 wt %, and the total amount of Al, Cu, and Ga is 2.22 wt %, Cu/Al is 1.26, Cu/Ga is 6, the total amount of Co, Ti, Zn, and Sn is 1.42 wt %, and the B content is 1.04 wt %. The NdFeB magnet intermediate is diffused at a high temperature of 900° C. for 10 hours, the aging temperature is 480° C. for 8 hours. The pressure of argon gas, which is circulated for cooling, is 1500 mbar.

2) The properties of the NdFeB magnet have been determined: the intrinsic coercivity (i.e. Hcj) is 2308.4 kA/m, the remanence (i.e. Br) is 1.25 T, and the thickness of grain boundary is 800 nm.

### Example 2

1) Prepare a NdFeB magnet intermediate, which meets the requirement that the total amount of Pr, Nd, and Ce is 32.79 wt %, the ratio of Pr/Nd is 0.05, the content of Dy is 0.98 wt %, and the total amount of Al, Cu, and Ga is 1.62 wt %, Cu/Al is 0.53, Cu/Ga is 2.5, the total amount of Co, Ti, Zn, and Sn is 1.47 wt %, and the B content is 1.08 wt %. The NdFeB magnet intermediate is diffused at a high temperature of 940° C. for 8 hours, the aging temperature is 500° C. for 6 hours. The pressure of argon gas, which is circulated for cooling, is 1000 mbar.

2) The properties of the NdFeB magnet are: the intrinsic coercivity (i.e. Hcj) is 2149.2 kA/m, the remanence (i.e. Br) is 1.32 T, and the thickness of grain boundary is about 300 nm, as shown in FIG. 3.

### Example 3

1) Prepare a NdFeB magnet intermediate, which meets the requirement that the total amount of Pr, Nd, and Ce is 37.75 wt %, the ratio of Pr/Nd is 0.53, and the total amount of Al, Cu, Ga, and Mg is 2.35 wt %, Cu/Al is 0.16, Cu/Ga is 0.75, Mg/Al is 1.11, the total amount of Co, Ti, Zn, and Sn is 1.5 wt %, and the B content is 1.1 wt %. The NdFeB magnet intermediate is diffused at a high temperature of 850° C. for 20 hours, the aging temperature is 460° C. for 10 hours. The pressure of argon gas, which is circulated for cooling, is 3000 mbar.

2) The properties of the NdFeB magnet are: the intrinsic coercivity (i.e. Hcj) is 1910.4 kA/m, the remanence (i.e. Br) is 1.28 T, and the thickness of grain boundary is 600 nm, as shown in FIG. 4.

### Example 4

1) Prepare a NdFeB magnet intermediate, which meets the requirement that the total amount of Pr, Nd, and Ce is 33.15 wt %, the ratio of Pr/Nd is 0.36, and the total amount of Al, Cu, and Ga is 1.41 wt %, Cu/Al is 0.29, Cu/Ga is 1.36, the total amount of Co, Ti, Zn, and Sn is 1.49 wt %, and the B content is 1.09 wt %. The NdFeB magnet intermediate is diffused at a high temperature of 960° C. for 6 hours, the aging temperature is 520° C. for 9 hours. The pressure of argon gas, which is circulated for cooling, is 500 mbar.

2) The properties of the NdFeB magnet are: the intrinsic coercivity (i.e. Hcj) is 1751.2 kA/m, the remanence (i.e. Br) is 1.33 T, and the thickness of grain boundary is 50 nm.

### Example 5

1) Prepare a NdFeB magnet intermediate, which meets the requirement that the total amount of Pr, Nd, and Ce is 37.75 wt %, the ratio of Pr/Nd is 0.15 and the total amount of Al, Cu, Ga, and Mg is 3.3 wt %, Cu/Al is 0.04, Cu/Ga is 0.4, the ratio of Mg/Al is 0.55. The total amount of Co, Ti, Zn, and Sn is 1.5 wt %, and the B content is 1.1 wt %. The NdFeB magnet intermediate is diffused at a high temperature of 900° C. for 12 hours, the aging temperature is 550° C. for 8 hours. The pressure of argon gas, which is circulated for cooling, is 2500 mbar.

2) The properties of the NdFeB magnet are: the intrinsic coercivity (i.e. Hcj) is 1990 kA/m, the remanence (i.e. Br) is 1.26 T, and the thickness of grain boundary is 700 nm.

### Example 6

1) Prepare a NdFeB magnet intermediate, which meets the requirement that the total amount of Pr, Nd, and Ce is 33.77 wt %, the ratio of Pr/Nd is 0.05, the total amount of Al, Cu, and Ga is 1.55 wt %, Cu/Al is 0.45, Cu/Ga is 2.15, the total amount of Co, Ti, Zn, and Sn is 1.47 wt %, and the B content is 1.08 wt %. The NdFeB magnet intermediate is diffused at a high temperature of 910° C. for 15 hours, the aging temperature is 600° C. for 11 hours. The pressure of argon gas, which is circulated for cooling, is 3000 mbar.

2) The properties of the NdFeB magnet are: the intrinsic coercivity (i.e. Hcj) is 1950.2 kA/m, the remanence (i.e. Br) is 1.3 T, and the thickness of grain boundary is 290 nm.

### Example 7

1) Prepare a NdFeB magnet intermediate, which meets the requirement that the total amount of Pr, Nd, and Ce is 33.77 wt %, the ratio of Pr/Nd is 0.05, the total amount of Al, Cu, and Ga is 1.32 wt %, Cu/Al is 1.11, Cu/Ga is 1.25, the total amount of Co, Ti, Zn, and Sn is 1.47 wt %, and the B content is 1.08 wt %. The NdFeB magnet intermediate is diffused at a high temperature of 880° C. for 10 hours, the aging temperature is 490° C. for 9 hours. The pressure of argon gas, which is circulated for cooling, is 1300 mbar.

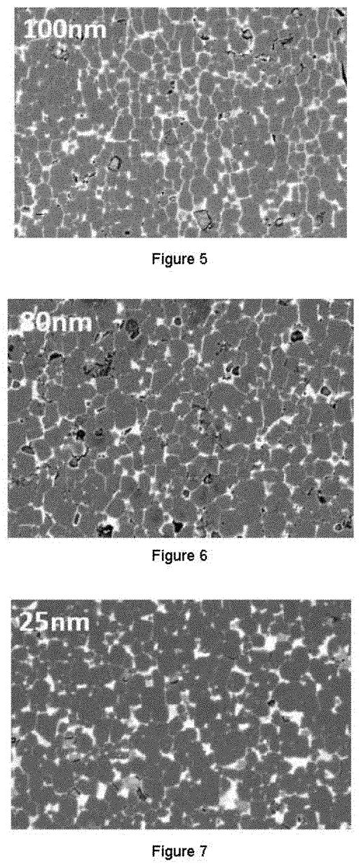

2) The properties of the NdFeB magnet are: the intrinsic coercivity (i.e. Hcj) is 1870.6 kA/m, the remanence (i.e. Br) is 1.32 T, and the thickness of grain boundary is 100 nm, as shown in FIG. 5.

### Example 8

1) Prepare a NdFeB magnet intermediate, which meets the requirement that the total amount of Pr, Nd, and Ce is 37.75 wt %, the ratio of Pr/Nd is 0.15, the total amount of Al, Cu, Ga, and Mg is 2.1 wt %, Cu/Al is 0.07, Cu/Ga is 0.25, Mg/Al is 1.5. The total amount of Co, Ti, Zn, and Sn is 1.5 wt %, and the B content is 1.1 wt %. The NdFeB magnet intermediate is diffused at a high temperature of 920° C. for 11 hours, the aging temperature is 420° C. for 10 hours. The pressure of argon gas, which is circulated for cooling, is 3500 mbar.

2) The properties of the NdFeB magnet are: the intrinsic coercivity (i.e. Hcj) is 1910.4 kA/m, the remanence (i.e. Br) is 1.33 T, and the thickness of grain boundary is 150 nm.

### Example 9

1) Prepare a NdFeB magnet intermediate, which meets the requirement that the total amount of Pr, Nd, and Ce is 33 wt %, the ratio of Pr/Nd is 0.03, the total amount of Al, Cu, and Ga is 1.36 wt %, Cu/Al is 0.23, Cu/Ga is 1.1. The total amount of Co, Ti, Zn, and Sn is 1.54 wt %, and the B content is 1.1 wt %. The NdFeB magnet intermediate is diffused at a high temperature of 860° C. for 9 hours, the aging temperature is 680° C. for 3 hours. The pressure of argon gas, which is circulated for cooling, is 800 mbar.

2) The properties of the NdFeB magnet are: the intrinsic coercivity (i.e. Hcj) is 1751.2 kA/m, the remanence (i.e. Br) is 1.36 T, and the thickness of grain boundary is 20 nm.

### Example 10

1) Prepare a NdFeB magnet intermediate, which meets the requirement that the total amount of Pr, Nd, and Ce is 34 wt %, the ratio of Pr/Nd is 0.48, the total amount of La and Sm is 0.6 wt %, the ratio of La/Sm is 0.8 the total amount of Al, Cu, Ga, and Mg is 1.4 wt %, Cu/Al is 1, Cu/Ga is 0.67, and Mg/Al is 3.5. The total amount of Co, Ti, Zn, and Sn is 1.6 wt %, and the B content is 1.1 wt %. The NdFeB magnet intermediate is diffused at a high temperature of 930° C. for 9 hours, the aging temperature is 660° C. for 4 hours. The pressure of argon gas, which is circulated for cooling, is 1700 mbar.

2) The properties of the NdFeB magnet are: the intrinsic coercivity (i.e. Hcj) is 1830.8 kA/m, the remanence (i.e. Br) is 1.35 T, and the thickness of grain boundary is 120 nm.

### Example 11

1) Prepare a NdFeB magnet intermediate, which meets the requirement that the total amount of Pr, Nd, and Ce is 35.95 wt %, the ratio of Pr/Nd is 0.55, the total amount of La and Sm is 0.54 wt %, the ratio of La/Sm is 0.93 the total amount of Al, Cu, Ga, and Mg is 1.9 wt %, Cu/Al is 1.2, Cu/Ga is 0.67, and Mg/Al is 4.2. The total amount of Co, Ti, Zn, and Sn is 1.08 wt %, and the B content is 0.92 wt %. The NdFeB magnet intermediate is diffused at a high temperature of 930° C. for 12 hours, the aging temperature is 510° C. for 5 hours. The pressure of argon gas, which is circulated for cooling, is 5000 mbar.

2) The properties of the NdFeB magnet are: the intrinsic coercivity (i.e. Hcj) is 1950.2 kA/m, the remanence (i.e. Br) is 1.31 T, and the thickness of grain boundary is 210 nm.

### Example 12

1) Prepare a NdFeB magnet intermediate, which meets the requirement that the total amount of Pr, Nd, and Ce is 31.51 wt %, the ratio of Pr/Nd is 0.37, the total amount of La and Sm is 0.53 wt %, the ratio of La/Sm is 0.5 the total amount of Al, Cu, and Ga is 1.01 wt %, Cu/Al is 1.9, and Cu/Ga is 1.25. The total amount of Co, Ti, Zn, and Sn is 1.07 wt %, and the B content is 1.09 wt %. The NdFeB magnet intermediate is diffused at a high temperature of 850° C. for 10 hours, the aging temperature is 570° C. for 6 hours. The pressure of argon gas, which is circulated for cooling, is 1800 mbar.

2) The properties of the NdFeB magnet are: the intrinsic coercivity (i.e. Hcj) is 1830.8 kA/m, the remanence (i.e. Br) is 1.33 T, and the thickness of grain boundary is 80 nm, as shown in FIG. 6.

### Example 13

1) Prepare a NdFeB magnet intermediate, which meets the requirement that the total amount of Pr, Nd, and Ce is 31.21 wt %, the ratio of Pr/Nd is 0.35, the total amount of La and Sm is 0.9 wt %, the ratio of La/Sm is 2 the total amount of Al, Cu, and Ga is 1.02 wt %, Cu/Al is 1.48, and Cu/Ga is 0.9. The total amount of Co, Ti, Zn, and Sn is 1.08 wt %, and the B content is 1.1 wt %. The NdFeB magnet intermediate is diffused at a high temperature of 880° C. for 6 hours, the aging temperature is 440° C. for 3 hours. The pressure of argon gas, which is circulated for cooling, is 2800 mbar.

2) The properties of the NdFeB magnet are: the intrinsic coercivity (i.e. Hcj) is 1671.6 kA/m, the remanence (i.e. Br) is 1.35 T, and the thickness of grain boundary is 25 nm, as shown in FIG. 7.

### Example 14

1) Prepare a NdFeB magnet intermediate, which meets the requirement that the total amount of Pr, Nd, and Ce is 31.72 wt %, the ratio of Pr/Nd is 0.41, the total amount of La and Sm is 1.1 wt %, the ratio of La/Sm is 0.93 the total amount of Al, Cu, and Ga is 1.03 wt %, Cu/Al is 2.75, and Cu/Ga is 1.83. The total amount of Co, Ti, Zn, and Sn is 1.06 wt %, and the B content is 1.08 wt %. The NdFeB magnet intermediate is diffused at a high temperature of 920° C. for 13 hours, the aging temperature is 460° C. for 9 hours. The pressure of argon gas, which is circulated for cooling, is 2500 mbar.

2) The properties of the NdFeB magnet are: the intrinsic coercivity (i.e. Hcj) is 1830.8 kA/m, the remanence (i.e. Br) is 1.34 T, and the thickness of grain boundary is 100 nm.

### Example 15

1) Prepare a NdFeB magnet intermediate, which meets the requirement that the total amount of Pr, Nd, and Ce is 30.91 wt %, the ratio of Pr/Nd is 0.35, the total amount of La and Sm is 2 wt %, the ratio of La/Sm is 1 the total amount of Al, Cu, and Ga is 0.77 wt %, Cu/Al is 1.35, and Cu/Ga is 0.9. The total amount of Co, Ti, Zn, and Sn is 1.08 wt %, and the B content is 1.1 wt %. The NdFeB magnet intermediate is diffused at a high temperature of 850° C. for 9 hours, the aging temperature is 620° C. for 5 hours. The pressure of argon gas, which is circulated for cooling, is 5500 mbar.

2) The properties of the NdFeB magnet are: the intrinsic coercivity (i.e. Hcj) is 1631.8 kA/m, the remanence (i.e. Br) is 1.38 T, and the thickness of grain boundary is 20 nm.

The NdFeB magnet 1 and the diffusion source 2 form the NdFeB magnet intermediate 3, as schematically illustrated in FIG. 1. Diffusion temperature, diffusion time, aging temperature, and aging time and the cooling Argon pressure with the composition of NdFeB magnet intermediate represent suitable parameters for controlling the grain boundary thickness and thereby an increase of the performance of the NdFeB magnet could be achieved. The NdFeB magnet intermediate compositions are shown in Table 1. Treatment process, rain boundary thickness and performance are displayed in Table 2. The coercivity of non-heavy rare earths can be higher than 1990 kA/m, and the coercivity of magnets containing heavy rare earths after treatment can be higher than 2308.4 kA/m.

TABLE 1

| Example | Pr, Nd, Ce | Pr/Nd | La, Sm | La/Sm | Tb, Dy, Ho | Al, Cu, Ga, Mg | Cu/Al | Cu/Ga | Mg/Al | Co, Ti, Zn, Sn | B | Fe |
|---|---|---|---|---|---|---|---|---|---|---|---|---|
| 1 | 34.67 | 0.16 | / | / | 1.13 | 2.22 | 1.26 | 6.00 | 0.00 | 1.42 | 1.04 | Bal. |
| 2 | 32.79 | 0.05 | / | / | 0.98 | 1.62 | 0.53 | 2.50 | 0.00 | 1.47 | 1.08 | Bal. |
| 3 | 37.75 | 0.53 | / | / | / | 2.35 | 0.16 | 0.75 | 1.11 | 1.50 | 1.10 | Bal. |
| 4 | 33.15 | 0.36 | / | / | / | 1.41 | 0.29 | 1.36 | 0.00 | 1.49 | 1.09 | Bal. |
| 5 | 37.75 | 0.15 | / | / | / | 3.30 | 0.04 | 0.40 | 0.55 | 1.50 | 1.10 | Bal. |
| 6 | 33.77 | 0.05 | / | / | / | 1.55 | 0.45 | 2.15 | 0.00 | 1.47 | 1.08 | Bal. |
| 7 | 33.77 | 0.05 | / | / | / | 1.32 | 1.11 | 1.25 | 0.00 | 1.47 | 1.08 | Bal. |
| 8 | 37.75 | 0.15 | / | / | / | 2.10 | 0.07 | 0.25 | 1.50 | 1.50 | 1.10 | Bal. |
| 9 | 33.00 | 0.03 | / | / | / | 1.36 | 0.23 | 1.10 | 0.00 | 1.64 | 1.10 | Bal. |
| 10 | 34.00 | 0.48 | 0.6 | 0.80 | / | 1.40 | 1.00 | 0.67 | 3.5 | 1.6 | 1.1 | Bal. |
| 11 | 35.95 | 0.55 | 0.54 | 0.93 | / | 1.90 | 1.20 | 0.67 | 4.20 | 1.08 | 0.92 | Bal. |
| 12 | 31.51 | 0.37 | 0.53 | 0.50 | / | 1.01 | 1.90 | 1.25 | 0.00 | 1.07 | 1.09 | Bal. |
| 13 | 31.21 | 0.35 | 0.90 | 2.00 | / | 1.02 | 1.48 | 0.90 | 0.00 | 1.08 | 1.10 | Bal. |
| 14 | 31.72 | 0.41 | 1.10 | 0.93 | / | 1.03 | 2.75 | 1.83 | 0.00 | 1.06 | 1.08 | Bal. |
| 15 | 30.91 | 0.35 | 2.00 | 1.00 | / | 0.77 | 1.35 | 0.90 | 0.00 | 1.08 | 1.10 | Bal. |

TABLE 2

| | Cooling | | | | | Thickness | | |
|---|---|---|---|---|---|---|---|---|
| | pressure | Diffusion | Diffusion | Aging | Aging | of G. B. | Hcj | Br |
| Example | (mbar) | Temp °C. | hours | Temp °C. | hours | (nm) | (kA/m) | (T) |
| 1 | 1500 | 900 | 10 | 480 | 8 | 800 | 2308.4 | 1.25 |
| 2 | 1000 | 940 | 8 | 500 | 6 | 300 | 2149.2 | 1.32 |
| 3 | 3000 | 850 | 20 | 460 | 10 | 600 | 1910.4 | 1.28 |
| 4 | 500 | 960 | 6 | 520 | 9 | 50 | 1751.2 | 1.33 |
| 5 | 2500 | 900 | 12 | 550 | 8 | 700 | 1990 | 1.26 |
| 6 | 3000 | 910 | 15 | 600 | 11 | 290 | 1950.2 | 1.3 |
| 7 | 1300 | 880 | 10 | 490 | 9 | 100 | 1870.6 | 1.32 |
| 8 | 3500 | 920 | 11 | 420 | 10 | 150 | 1910.4 | 1.33 |
| 9 | 800 | 860 | 9 | 680 | 3 | 20 | 1751.2 | 1.36 |
| 10 | 1700 | 930 | 9 | 660 | 4 | 120 | 1830.8 | 1.35 |
| 11 | 5000 | 930 | 12 | 510 | 5 | 210 | 1950.2 | 1.31 |
| 12 | 1800 | 850 | 10 | 570 | 6 | 80 | 1830.8 | 1.33 |
| 13 | 2800 | 880 | 6 | 440 | 3 | 25 | 1671.6 | 1.35 |
| 14 | 2500 | 920 | 13 | 460 | 9 | 100 | 1830.8 | 1.34 |
| 15 | 5500 | 850 | 9 | 620 | 5 | 20 | 1631.8 | 1.38 |

From the above embodiments, it can be seen that the composition of the NdFeB magnet intermediate and the experimental conditions can effectively form different thicknesses of grain boundaries, including non-heavy rare earth NdFeB magnets and heavy rare earth NdFeB magnets.

It is mainly manifested in the following aspects:

1) Different thickness of grain boundary can be controlled effectively, see for example Examples 2, 3, 7, 12, and 13 whose thicknesses of the grain boundary are 300, 600, 100, 80, and 25 nm, respectively.

2) The process conditions of diffusion temperatures, aging temperatures and Ar gas cooling pressure can control the thickness of grain boundary.

3) The method has not harsh requirements for C, O, and N and other atmosphere gases, which makes the industrial process for preparing of NdFeB magnets more easily. Thereby, the overall production costs of NdFeB magnets can be reduced.

4) The NdFeB magnets show distinguishable grain boundary structures of different thicknesses, and have typical boundary characteristics different from conventional magnets.

What is claimed is:

1. A preparation method for a sintered type NdFeB permanent magnet, the method including the steps of:
(1) Covering a NdFeB magnet with a diffusion source to form a NdFeB magnet intermediate, the chemical composition of the NdFeB magnet intermediate is expressed in weight percentage as [R1ₓR2_{y}R3_{1-x-y}]ₐM_{b}B_{c}Fe_{100-a-b-c},
with 0.8≤x≤1, 0≤y≤0.08, 32≤a≤38, 0.5≤b≤7, and 0.95≤c≤1.2,
R1 being one or more of Nd, Pr, and Ce,
R2 being one or more of La and Sm,
R3 being one or more of Tb, Dy, and Ho,
M being one or more of Al, Cu, Ga, Ti, Co, Mg, Zn, Nb, Mo, and Sn, and
wherein the diffusion source refers to an alloy including two or more of the alloying elements Nd, Pr, Ce, La, Ho, Tb, Dy, Ga, Al, Cu, and Mg;
(2) Putting the NdFeB magnet intermediate into a furnace and performing a diffusion treatment and subsequently an aging treatment, wherein the aging treatment is divided into a heating step and a cooling step, and
wherein the cooling step is carried out by means of argon gas positive pressure circulation cooling such that NdFeB magnets with a thickness of grain boundaries in the range of 10 nm to 1 μm are formed, and a structure of the grain boundaries includes a main phase, grain boundary (a), grain boundary (b), and grain boundary (c),
wherein grain boundary (a) meets the following conditions: R≥55 wt % or 35 wt %≤R≤40 wt %, 10 wt %≤M≤28 wt %, where 3:1≤Nd/(Pr or Ce or La)≤2:1, and (Cu+Al+Ga)/M≥0.8;
grain boundary (b) meets the following conditions: 40 wt %≤R≤55 wt %, 10 wt %≤M≤20 wt %, 9:10≤Nd/(Pr or Ce or La)≤2, and (Cu+Co+Al)/M≥0.9; and
grain boundary (c) meets the following conditions: 25 wt % R≤50 wt % or R≥60%, 0≤M≤10 wt %,
where R in the grain boundaries (a) to (c) refers to the total amount of rare earths, and M refers to the total amount of Al, Cu, Ga, Ti, Co, Mg, Zn, Nb, Mo, and Sn.

2. The method of claim 1, wherein covering the diffusion source on the NdFeB magnet is performed by one of magnetron sputtering coating, vapor deposition coating, slurry coating, and sticking powder coating.

3. The method of claim 1, wherein the NdFeB magnet intermediate is a non-heavy rare earth type NdFeB magnet intermediate or a heavy rare earth type NdFeB magnet intermediate.

4. The method of claim 3, wherein the chemical composition of the non-heavy rare earth NdFeB magnet intermediate is [R1ₓR2₁₋ₓ]ₐM_{b}B_{c}Fe_{100-a-b-c} with
0.94≤x≤1, 32≤a≤37, 1.55≤b≤7, and 0.95≤c≤1.2,
R1 being one or more of Nd, Pr, and Ce,
R2 being one or two of La and Sm, and
M being one or more of Al, Cu, Ga, Ti, Co, Mg, Zn, and Sn.

5. The method of claim 4, wherein the chemical composition of the non-heavy rare earth NdFeB magnet intermediate fulfils one or more of the following conditions:
when R1 includes Nd and Pr, their weight ratio is 0.03≤Pr/Nd≤0.6;
when R2 includes La and Sm, their weight ratio is 0.5≤La/Sm≤2;
when M includes Cu and Al, their weight ratio is 0≤Cu/Al≤6.5;
when M includes Cu and Ga, their weight ratio is 0≤Cu/Ga≤5; and
when M includes Mg and Al, their weight ratio is 0≤Mg/Al≤6.

6. The method of claim 3, wherein the chemical composition of the heavy rare earth type NdFeB magnet intermediate is [R1ₓR3_{y}R2_{1-x-y}]ₐM_{b}B_{c}Fe_{100-a-b-c} with
32.5≤a≤38, 0.8≤x≤0.98, 0.003≤y≤0.3, 1.5≤b≤7, and 0.95≤c≤1.2,
R1 being one or more of Nd, Pr and Ce,
R2 being one or two of La and Sm,
R3 being one or more of Tb, Dy and Ho, and
M being one or more of Al, Cu, Ga, Ti, Co, Mg, Zn, and Sn.

7. The method of claim 6, wherein the chemical composition of the non-heavy rare earth NdFeB magnet intermediate fulfils one or more of the following conditions:
when R1 includes Nd and Pr, and 0.03≤Pr/Nd≤0.4;
when R2 includes La and Sm, their weight ratio is 0.5≤La/Sm≤2;
when M includes Cu and Al, their weight ratio is 0≤Cu/Al≤6.5;
when M includes Cu and Ga, their weight ratio is 0≤Cu/Ga≤5; and
when M includes Mg and Al, their weight ratio is 0≤Mg/Al≤6.

8. The method of claim 1, wherein the NdFeB magnet is cooled down by argon gas passing through a tube-fin type annular exchanger.

9. The method of claim 1, wherein a pressure of the argon gas used for argon gas positive pressure circulation cooling is in the range of 1 bar to 5 bar.

10. The method of claim 1, wherein the temperature for diffusion treatment of the NdFeB magnet is in the range of 850° C. to 920° C. for 6 h to 20 h, and wherein the temperature for aging treatment is in the range of 420° C. to 680° C. for 3 h to 10 h.

11. The method of claim 2, wherein the NdFeB magnet intermediate is a non-heavy rare earth type NdFeB magnet intermediate or a heavy rare earth type NdFeB magnet intermediate.

12. The method of claim 2 wherein the NdFeB magnet is cooled down by argon gas passing through a tube-fin type annular exchanger.

13. The method of claim 3 wherein the NdFeB magnet is cooled down by argon gas passing through a tube-fin type annular exchanger.

14. The method of claim 11 wherein the NdFeB magnet is cooled down by argon gas passing through a tube-fin type annular exchanger.

15. The method of claim 2, wherein a pressure of the argon gas used for argon gas positive pressure circulation cooling is in the range of 1 bar to 5 bar.

16. The method of claim 3, wherein a pressure of the argon gas used for argon gas positive pressure circulation cooling is in the range of 1 bar to 5 bar.

17. The method of claim 11, wherein a pressure of the argon gas used for argon gas positive pressure circulation cooling is in the range of 1 bar to 5 bar.

18. The method of claim 2, wherein the temperature for diffusion treatment of the NdFeB magnet is in the range of 850° C. to 920° C. for 6 h to 20 h, and wherein the temperature for aging treatment is in the range of 420° C. to 680° C. for 3 h to 10 h.

19. The method of claim 3, wherein the temperature for diffusion treatment of the NdFeB magnet is in the range of 850° C. to 920° C. for 6 h to 20 h, and wherein the temperature for aging treatment is in the range of 420° C. to 680° C. for 3 h to 10 h.

20. The method of claim 11, wherein the temperature for diffusion treatment of the NdFeB magnet is in the range of 850° C. to 920° C. for 6 h to 20 h, and wherein the temperature for aging treatment is in the range of 420° C. to 680° C. for 3 h to 10 h.
